(19) United States
(12) Patent Application Publication
(10) Pub. No.: US 2015/0016921 A1
(43) Pub. Date: Jan. 15, 2015

(54) ELECTRICAL FITTING CIRCULAR LOCKNUT

(71) Applicant: Allen D. Fischbein, Hillsdale, NJ (US)

(72) Inventor: Allen D. Fischbein, Hillsdale, NJ (US)

(21) Appl. No.: 13/939,256

(22) Filed: Jul. 11, 2013

(51) Int. Cl. F16B 39/12

(52) U.S. Cl. CPC F16B 39/12
USPC 411/427

(57) ABSTRACT

A locknut for use in electrical conduit installations is disclosed. The lock nut is fabricated by a precise manufacturing process resulting in a high strength and precisely manufactured locknut. By use of the machining process, higher strength and higher quality materials can be utilized. The locknut provides a more secure gripping surface as a result of larger gripping surface on the exterior perimeter thereof.

### BACKGROUND OF THE INVENTION

The present invention is directed to the field of hardware used in connection with electrical conduits and connections. In particular, the present invention is directed to a new and improved design for a locknut used to secure connectors to conduit boxes in electrical conduit installations. The available locknuts suffer from various defects. The defects include difficulty in manufacturing accurately on a repeated basis, low material strength, and low quality materials. The primary object of the present invention is to cure the defects with a new locknut manufactured through a more accurate machining process allowing for the use of higher quality and higher strength materials.

### SUMMARY OF THE INVENTION

An improved locknut for use in electrical conduit installations comprising: a generally circular exterior perimeter; a generally circular interior passageway for receipt of an electrical cable therein comprising threads therein adapted to engage mating threads on an electrical connector; wherein the locknut is formed by a machining process and a plurality of notches are knurled onto the exterior perimeter that form a plurality of edges with a larger arc than the notches and the plurality of edges are adapted for gripping and securing the locknut to the electrical connector.

### BRIEF DESCRIPTION OF THE DRAWINGS

FIG. 1 is an isometric view of an embodiment of the present invention.

FIG. 2 is a top elevation view of an embodiment of the present invention.

FIG. 3 is a side elevation view of an embodiment of the present invention.

FIG. 4 is a cut-away side elevation view of an embodiment of the present invention.

FIG. 5 is a side elevation view of an embodiment of the present invention installed on a connector.

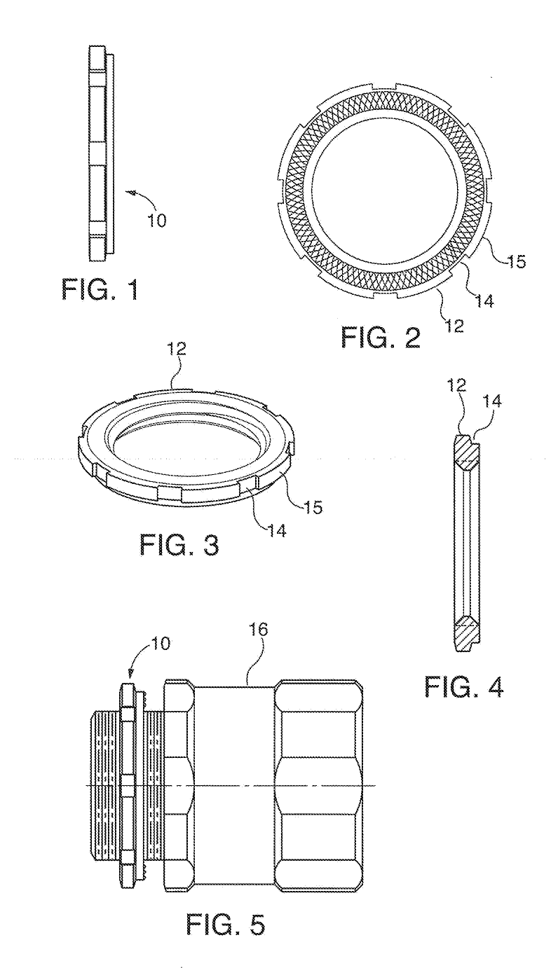

### DETAILED DESCRIPTION OF THE PRESENT INVENTION

The presently preferred embodiment of the present invention will now be described with reference to the appended drawings. Those of ordinary skill in the art will recognize that many obvious modifications may be made thereto without departing from the sprit or scope of the present invention.

The conduit locknut 10 of the present invention is illustrated n the drawings. It is directed to use with an electrical conduit connector 16 as shown in FIG. 6. The locknut 10 is fabricated from a machining process rather than being punched and tapped as in available locknuts. Typically the available locknuts have an exterior perimeter incorporating a gripping surface on the edge that is fabricated with a plurality of relatively short bent edges. The gripping surface is utilized in conjunction with a wrench or other similar mechanical device to tighten the locknut and secure it to a connector.

The locknut 10 of the present invention consists of a circular exterior perimeter 12 that is fabricated by knurling. The locknut 10 is fabricated from [insert material]. It is formed by knurling the circular exterior perimeter 12 which results in a plurality of notches 14 formed on the exterior perimeter 12. A plurality of edges 15 are formed between the notches 14. The plurality of edges 15 are of a substantially larger arc on the exterior perimeter 12 than the corresponding arc of the plurality of notches 14. In addition, the plurality of edges 15 are formed with a longer exterior surface than the relatively small bent edges on the available locknuts. The present invention thus improves upon the prior art where a series of 6 tabs extend outward from the circular perimeter of the locknut. The present invention thus allows for more secure gripping of the outer perimeter 12 when the locknut 10 is tightened on the connector.

As shown in FIG. 6, the locknut 10 is used in conjunction with an electrical connector 16. An electrical cable is placed through the interior of the connector 16. The connector 16 is used to securely connect the cable into an electrical conduit box or other similar enclosure. The locknut 10 securely tightens the connector 16 to the conduit box.

Those of ordinary skill in the art will recognize that the foregoing merely represents, an embodiment of the present invention. Many obvious modifications may be made thereto without departing from the spirit or scope of the present invention as set forth in the appended claims.

What is claimed is:

1) An improved locknut for use in electrical conduit installations comprising:
a) a generally circular exterior perimeter;
b) a generally circular interior passageway for receipt of an electrical cable therein comprising threads therein adapted to engage mating threads on an electrical connector;
wherein the locknut is formed by a machining process and a plurality of notches are knurled onto the exterior perimeter that form a plurality of edges with a larger arc than the notches and the plurality of edges are adapted for gripping and securing the locknut to the electrical connector.
